(19) United States
(12) Patent Application Publication
(10) Pub. No.: US 2012/0169170 A1
(43) Pub. Date: Jul. 5, 2012

(54) MAGNET MATERIAL, PERMANENT MAGNET, MOTOR AND ELECTRIC GENERATOR

(75) Inventors: Shinya SAKURADA, Tokyo (JP); Yosuke Horiuchi, Chigasaki-shi (JP)

(73) Assignee: KABUSHIKI KAISHA TOSHIBA, Tokyo (JP)

(21) Appl. No.: 13/416,424

(22) Filed: Mar. 9, 2012

Related U.S. Application Data
(63) Continuation of application No. PCT/JP09/04538, filed on Sep. 11, 2009.

(51) Int. Cl. H02K 21/00; H01F 7/02; C22C 38/00

(52) U.S. Cl. 310/152; 420/83; 335/302

(57) ABSTRACT

In an embodiment, a magnet material includes a composition represented by Rₓ(Nb₁₋ₚZrₚ)_{y}B_{Z}(T_{1-q}M_{q})_{100-x-y-z}, where R is an element selected from rare earth elements and 50 at. % or more of R is Sm, T is Fe alone or a mixture of Fe and Co containing 50 at. % or more of Fe, M is at least one element selected from Ni, Cu, V, Cr, Mn, Al, Si, Ga, Ta and W, p is 0≦p≦0.5, q is 0≦q≦0.2, x is 4≦x≦15 at. %, y is 1≦y≦4 at. %, z is 0.001≦z<4 at. %, and a structure having a TbCu₇ crystal phase as a main phase.

### CROSS-REFERENCE TO RELATED APPLICATION

This application is a continuation of prior International Application No. PCT/JP2009/004538, filed on Sep. 11, 2009; the entire contents of all of which are incorporated herein by reference.

### FIELD

Embodiments described herein relate generally to a magnet material, a permanent magnet, a motor and an electric generator.

### BACKGROUND

As a high performance permanent magnet, rare earth magnets such as Sm—Co based magnets and Nd—Fe—B based magnets are known. It is demanded to improve magnetization of the permanent magnet so as to provide miniaturization and electric power saving of various electric appliances. As a specimen of the above permanent magnet, there is a rare earth magnet including a composition containing rare earth elements, zirconium, boron and iron as main components, and a TbCu₇ crystal phase as a main phase. The permanent magnet has a high concentration of iron in the main phase and high saturation magnetization, but its coercive force is not necessarily enough.

As a rare earth magnet similar to the above-described permanent magnet, there is a known permanent magnet which includes R—Fe—B based alloy composition (R: rare earth element) containing 4 at. % or more of boron (B), and a structure having a TbCu₇ crystal phase as a main phase. The rare earth magnet consists essentially of a microcrystalline phase having an average crystal grain diameter of less than 5 nm or an amorphous phase. The permanent magnet has a high coercive force, but has a disadvantage that degradation in magnetization cannot be avoided because it contains 4 at. % or more of boron. Therefore, there are demands for a permanent magnet which has established both coercive force and residual magnetization.

### BRIEF DESCRIPTION OF THE DRAWINGS

FIG. 1 is a view showing a variable magnetic flux motor according to an embodiment.

FIG. 2 is a view showing a variable magnetic flux electric generator according to an embodiment.

### DETAILED DESCRIPTION

According to one embodiment, there is provided a magnet material having a composition represented by a general formula:

Rₓ(Nb₁₋ₚZrₚ)_{y}B_{Z}(T_{1-q}M_{q})_{100-x-y-z} (1)

where, R is at least one element selected from rare earth elements and 50 at. % or more of R is Sm, T is Fe alone or a mixture of Fe and Co containing 50 at. % or more of Fe, M is at least one element selected from Ni, Cu, V, Cr, Mn, Al, Si, Ga, Ta and W, p is a number (atomic ratio) satisfying 0≦p≦0.5, q is a number (atomic ratio) satisfying 0≦q≦0.2, x is a number satisfying 4≦x≦15 at. %, y is a number satisfying 1≦y≦4 at. %, and z is a number satisfying 0.001≦z<4 at. %. The magnet material includes a TbCu₇ crystal phase (phase having a TbCu₇ crystalline structure) as a main phase.

In the magnet material of the embodiment, the TbCu₇ crystal phase as the main phase provides magnetic characteristics. The main phase is a phase having a maximum occupation amount in the magnet material. If a content ratio of the TbCu₇ crystal phase is excessively low, the magnetic characteristics of the main phase cannot be reflected sufficiently in the magnet material. Therefore, the content ratio of the TbCu₇ crystal phase is preferably 50% or more in a volume ratio, and more preferably 80 vol % or more. In addition, it is desirable that the magnet material of this embodiment is substantially composed of the TbCu₇ crystal phase excepting an impurity phase such as α-Fe phase.

In the TbCu₇ crystal phase configuring the main phase of the magnet material, a ratio (c/a) of a lattice constant c with respect to a lattice constant a is preferably 0.860 or more. The ratio c/a of the TbCu₇ crystal phase relates closely to concentrations of Fe and Co of the TbCu₇ crystal phase, and the concentrations of Fe and Co increase as the ratio c/a increases. The magnetic characteristics such as saturation magnetization of the magnet material can be improved by increasing the concentrations of Fe and Co in the TbCu₇ crystal phase. This effect becomes remarkable when the ratio c/a is 0.860 or more. The ratio c/a of the TbCu₇ crystal phase can be controlled depending on the ratio of constituents of the magnet material and the processing conditions.

In a case where individual crystal grains act independently in an isotropic magnet material, it is general that a ratio (Mr/Ms) of residual magnetization (Mr) to saturation magnetization (Ms) does not exceed 0.5. But, when the crystal grains made fine are bonded by exchange interaction via the crystal grain boundary, even the isotropic magnet material has occasionally the ratio Mr/Ms exceeding 0.5. That is, it becomes possible to improve the residual magnetization by forming a fine crystal texture of the isotropic magnet material containing boron (B) and increasing the exchange interaction among the crystal grains.

It is considered that the above situation relies on the behavior of the boron described below. The boron is taken into the magnet material by for example penetrating into an interstitial position of the TbCu₇ crystal phase or bonding with rare earth elements and transition metal elements to form a grain boundary phase. The boron taken into the magnet material shows an effect of enhancing the exchange interaction among the crystal grains by making fine the crystal grains and affecting on a grain boundary structure. Therefore, it becomes possible to make the magnet material exhibit a property that the ratio Mr/Ms exceeds 0.5.

Accordingly, the magnet material of this embodiment has the alloy composition (alloy composition containing boron) represented by the formula (1). It is preferable that the magnet material has a microcrystalline texture having the TbCu₇ crystal phase as the main phase. The average crystal grain diameter of the magnet material is preferably 100 nm or less, and more preferably 50 nm or less. The residual magnetization of the magnet material can be enhanced by making microcrystalline grains of the magnet material having the TbCu₇ crystal phase as the main phase. But, if the content of the boron is excessively large, saturation magnetization of the magnet material lowers conspicuously because the boron is a non-magnetic element.

In a case where a quenched thin alloy strip is produced by for example melt-spun method, the alloy material containing a large amount of boron can realize amorphization at a lower roll peripheral velocity. Further, a fine crystal texture can be obtained by performing heat treatment under appropriate conditions. But, if the boron content is large, magnetization is lowered. Therefore, according to this embodiment, niobium (Nb) is contained as an essential component into the magnet material, and the boron content is reduced. The niobium can improve the effect of enhancing the exchange interaction while suppressing the saturation magnetization from lowering in order to compensate the making of the microcrystalline grains of the magnet material. Therefore, it becomes possible to realize a magnet material having both large coercive force (e.g., coercive force exceeding 320 kA/m) and high residual magnetization (residual magnetization exceeding 1T).

Action and contents of the individual constituents of the magnet material represented by the formula (1) are described below. Element R is an element selected from rare earth elements (La, Ce, Pr, Nd, Sm, Eu, Gd, Tb, Dy, Ho, Er, Tm, Lu, and Y) containing yttrium. The element R provides the magnet material with magnetic anisotropy and large coercive force. Especially, the coercive force of the magnet material is reproducibly improved when samarium (Sm) is used, so that it is determined that Sm makes 50 at. % or more of the element R. It is preferable that elements other than Sm are at least one selected from cerium (Ce), praseodymium (Pr) and neodynium (Nd).

Content x of the element R is determined to be in a range of 4 to 15 at. %. When the content x of the element R is less than 4 at. %, the magnetic anisotropy lowers heavily, and a magnet material having large coercive force cannot be obtained. If the element R is contained excessively, the saturation magnetization of the magnet material lowers, so that the content x of the element R is determined to be 15 at. % or less. It is more preferable that the content x of the element R is in a range of 6 to 10 at. %.

Boron (B) is an element important to obtain a fine TbCu₇ crystal phase. When the TbCu₇ crystal phase is made fine, large coercive force can be obtained, and high residual magnetization is realized on the basis of the effect of enhancing the exchange interaction among the above-described crystal grains. But, if the content of the boron is excessively large, the saturation magnetization lowers conspicuously because the boron is a non-magnetic element. Therefore, content Z of the boron is determined to be less than 4 at. %. Meanwhile, if the boron content is excessively small, the effect of enhancing the exchange interaction among the crystal grains cannot be obtained sufficiently, and the residual magnetization cannot be avoided from lowering even if the saturation magnetization is high. Therefore, the content Z of the boron is determined to be 0.001 at. % or more. It is more preferable that the content Z of the boron is determined to be in a range of 0.1 to 3 at. %.

Niobium (Nb) is an element important to reduce the boron content and to make microcrystallization of the TbCu₇ crystal phase. In other words, it becomes possible to realize the microcrystalline grains of the magnet material in which the boron content is reduced by containing the niobium as an essential element. If content y of the niobium is less than 1 at. %, the magnet material cannot be made into microcrystalline grains sufficiently. Meanwhile, if the content y of the niobium exceeds 4 at. %, the magnetization lowers. Therefore, it is determined that the content y of the niobium is in a range of 1 to 4 at. %, and more preferably in a range of 2 to 3 at. %.

The niobium (Nb) may be partially substituted by zirconium (Zr). Thus, the magnet material can be made into microcrystalline grains more easily. But, if the amount of niobium substituted by the zirconium becomes excessively large, the coercive force of the magnet material lowers considerably, and the magnetic characteristics of the magnet material cannot be improved comprehensively. Therefore, the substituted amount by the zirconium is determined to be 50 at. % or less of the niobium. Even when the niobium is partially substituted by the zirconium, the niobium content y in total is determined to be in a range of 1 to 4 at. %.

Element T is an element selected from iron (Fe) and cobalt (Co), and serves to increase the saturation magnetization of the magnet material. When Fe is used as the element T, the saturation magnetization of the magnet material can be improved. The element T is determined to be Fe alone or a mixture of Fe and Co containing 50 at. % or more of Fe. It is preferable that the element T is contained in 70 at. % or more in the magnet material. Thus, the saturation magnetization of the magnet material can be increased effectively.

The element T may be partially substituted by at least one element M selected from nickel (Ni), copper (Cu), vanadium (V), chromium (Cr), manganese (Mn), aluminum (Al), silicon (Si), germanium (Ga), tantalum (Ta), and tungsten (W). Thus, a ratio of the main phase occupying the magnet material can be increased or the amount of the element T in the main phase can be increased. If the substitution amount by the element M becomes excessively large, the saturation magnetization is decreased. The substitution amount by the element M is determined to be 20 at. % or less of the element T. In a case where the element T is partially substituted by the element M, it is preferable that the ratio of Fe in the total amount is 50 at. % or more. The magnet material is allowed to contain inevitable impurities such as oxides.

For example, the magnet material of this embodiment is produced as follows. First, an alloy ingot containing predetermined amounts of individual elements is prepared by an arc melting method or a high-frequency melting method. The alloy ingot is cut into small pieces, which are then melted by high frequency induction heating or the like, and a quenched thin alloy strip is produced by applying the melt-spun method. It is preferable that the melt-spun method produces a quenched thin alloy strip having an average thickness in a range of 10 to 30 μm by pouring the melted alloy to a cooling roll (single roll or twin roll) rotating at a circumferential velocity of 20 m/sec or more.

Subsequently, the quenched thin alloy strip is heated at a temperature of 300 to 1000° C. for 0.1 to 10 hours. A magnet material having a microcrystalline texture can be obtained by heating the quenched thin alloy strip having the average thickness in a range of 10 to 30 μm. According to the melt-spun method, if the circumferential velocity of the cooling roll is less than 20 m/sec, amorphization of the quenched thin alloy strip becomes insufficient, and the crystal grains forming the magnet material tend to become coarse after the heat treatment. It is preferable that the circumferential velocity of the cooling roll is determined to be 30 m/sec or more. In addition, the thickness of the quenched thin alloy strip can also be controlled by adjusting a gap between a melted metal injecting nozzle and the cooling roll, and an injection pressure.

The magnet material may be produced by applying a quenching method such as a rotary disc method, a gas atomizing method or the like instead of the melt-spun method. In addition, it is also possible to produce the magnet material by applying a mechanical alloying method or a mechanical grinding method that applies mechanical energy to a raw material mixture containing predetermined amounts of individual elements to accomplish alloying by a solid phase reaction. If necessary, the magnet materials produced by the above methods are heated. Individual production steps (rapid cooling step, solid phase reaction step, and heat treatment step) of the magnet material are preferably performed in an inert gas atmosphere of Ar, He or the like to suppress deterioration of the magnetic characteristics due to oxidation.

As described above, it is preferable that the magnet material of this embodiment is formed of the thin alloy strip which is obtained by heating the quenched thin alloy strip having an average thickness in a range of 10 to 30 μm. Thus, a microcrystalline texture contributing to the improvement of residual magnetization can be reproducibly obtained. In a case where the heat treatment is performed in the permanent magnet production step, the heat treatment step of the quenched thin alloy strip can be omitted. If necessary, the magnet material is used to produce the permanent magnet after it is pulverized. In a case where the magnet material is pulverized and used, it is preferable that the powder (alloy powder) has a particle size in a range of a few ten μm to a few hundred μm. Even when the thin alloy strip is pulverized, there remain traces of the thin strip shape having the average thickness in a range of 10 to 30 μm.

The magnet material of this embodiment is used as a permanent magnet by applying a bond magnet or a sintered magnet. The bond magnet is generally produced by mixing a pulverized magnet material (alloy powder) and a binder and performing compression molding or injection molding. As the binder, a synthetic resin such as epoxy resin, nylon or the like is used. In a case where a thermosetting resin such as epoxy resin is used as the binder, it is preferable to perform curing treatment at a temperature of 100 to 200° C. after the compression molding. In a case where a thermoplastic resin such as nylon is used as the binder, it is desirable to use an injection molding method. In the compression molding step, a bond magnet having high magnetization can be obtained by applying a magnetic field to arrange the crystal orientation of the magnet material (alloy powder).

To produce the bond magnet, it is also possible to apply a mixture of a magnet material (alloy powder) and a low melting point metal or a low melting point alloy. Such a mixture is compression molded to produce a metal bond magnet. As the low melting point metal used to produce the metal bond magnet, there can be used a metal such as Al, Pb, Sn, Zn, Cu, Mg or the like. As the low melting point alloy, an alloy of the above metals can be used.

To produce the sintered magnet, it is preferable to apply a pressure sintering method such as hot pressing, hot isostatic pressing (HIP), spark plasma sintering or the like to integrate the magnet material (alloy powder) as a high density molded body. In the pressing step to produce the sintered magnet, the sintered magnet having high magnetization can be obtained by applying a magnetic field to arrange the crystal orientation of the magnet material. It is also possible to obtain the sintered magnet which has an easy magnetizing axis direction of the magnet material oriented by carrying out a plastic deformation processing while pressing at a temperature of 300 to 700° C. after the pressing step.

The permanent magnet (bond magnet or sintered magnet) of this embodiment is suitably used for the permanent magnet motor and the permanent magnet electric generator. The motor and the electric generator using the permanent magnet are excellent in efficiency in comparison with conventional induction motors and electric generators and can be made to have a small size, noise reduction and the like. Therefore, the permanent magnet is widespread as various home electrical appliance motors, drive motors for railroad vehicles, hybrid vehicles (HEV) and electric vehicles (EV), electric generators and the like. Higher efficiency, smaller size, and lower cost can be achieved by the permanent magnet motor or the electric generator provided with the permanent magnet of this embodiment.

As specific examples of the motor and the electric generator using the permanent magnet of this embodiment, there are a variable magnetic flux motor and a variable magnetic flux electric generator. The permanent magnet of this embodiment can be applied to both of the variable magnet and the stationary magnet of the variable magnetic flux motor and the variable magnetic flux electric generator, and has characteristics particularly suitable as a variable magnet. By applying the permanent magnet of this embodiment to the variable magnetic flux motor and the variable magnetic flux electric generator, a system can be made to be highly efficient, compact, inexpensive and the like. The technologies disclosed in the related arts can be applied to the structure and the drive system of the variable magnetic flux motor.

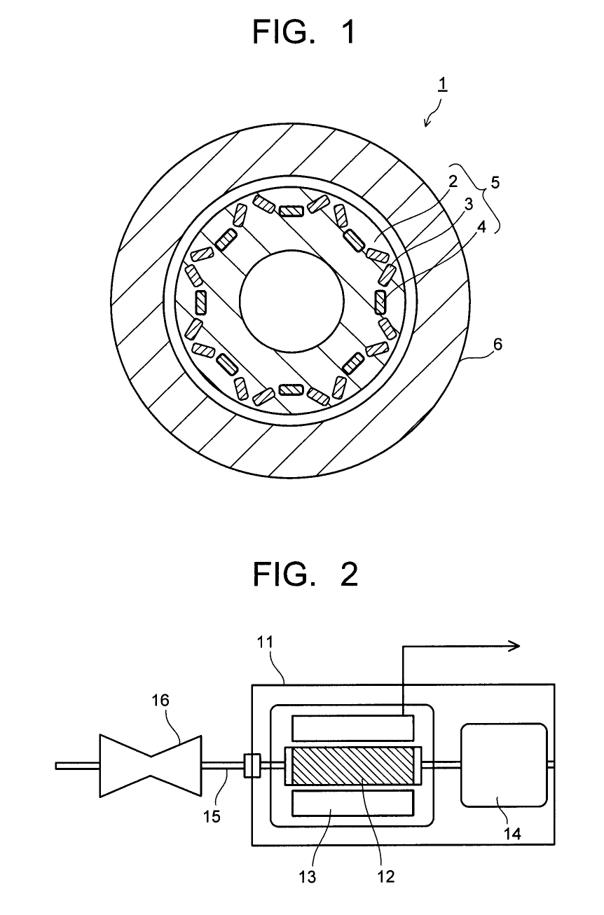

As shown in FIG. 1, a variable magnetic flux motor 1 is provided with a rotor 5, which has stationary magnets 3 and variable magnets 4 arranged in a core 2, and a stator 6 having the same structure as that of a conventional motor. As shown in FIG. 2, a variable magnetic flux electric generator 11 is provided with a rotor coil 12 having stationary magnets and variable magnets, a stator coil 13 and a brush 14. The variable magnetic flux electric generator 11 operates to generate power by rotating a shaft 15 mounted on the rotor coil 12 by a turbine 16.

### EXAMPLES

Specific examples according to the embodiments and their evaluated results are described below.

### Example 1

Individual raw materials Sm, Nb, Fe, Co and B of high purity were weighed to obtain them in predetermined amounts and arc-melted in an Ar gas atmosphere to prepare an ingot. A small piece was cut from the ingot, then put into a quartz nozzle and melted by high frequency induction heating in the Ar gas atmosphere. Subsequently, the melted alloy was injected onto a copper roll rotating at a circumferential velocity of 30 m/sec to produce a quenched thin alloy strip. Twenty samples were arbitrarily obtained from the obtained quenched thin alloy strip, and they were measured for their thickness with a micrometer to find that their average value (average thickness) was 22 μm.

Subsequently, the quenched thin alloy strip was vacuum-sealed in a quartz tube and undergone heat treatment at 650° C. for one hour. After the heat treatment, the quenched thin alloy strip was examined for its produced phase by X-ray diffraction. As a result, it was confirmed that all diffraction peaks excepting minute α-Fe diffraction peaks in the X-ray diffraction pattern are indexed in terms of a hexagonal TbCu₇ crystalline structure and the produced phase is substantially formed of the TbCu₇ crystal phase excepting an α-Fe phase as an inevitable impurity. It was also found from the X-ray diffraction result that lattice constants of the TbCu₇ crystal phase can be evaluated as a=0.4844 nm and c=0.4231 nm, and a ratio of lattice constants (c/a) is 0.8735.

In addition, it was confirmed as a result of composition analysis by ICP that the quenched thin alloy strip after the heat treatment has a composition Sm_{8.0}Nb_{3.4}B_{3.8}Co_{14.4}Fe_{bal}. A crystal grain boundary was copied from a TEM texture picture of the quenched thin alloy strip after the heat treatment, a crystal grain diameter was measured as a diameter of a corresponding circle to determine an average crystal grain diameter, and the crystal phase (substantially formed of the TbCu₇ crystal phase) had an average crystal grain diameter of 30 nm. The magnetic characteristics of the quenched thin alloy strip after the heat treatment were measured by VSM (vibrating sample magnetometer) to find that residual magnetization was 1.03 T, and coercive force was 360 kA/m. At that time, a demagnetizing field was not corrected.

The quenched thin alloy strip after the heat treatment was then pulverized to a particle size of 100 μm or less by using a mortar. Even after the pulverization, there remained traces (thickness) of the quenched thin alloy strip. The magnet material powder was mixed with 2% by weight of epoxy resin and compression-molded under a pressure of 800 MPa. Then, the compression-molded body was subjected to curing treatment at 150° C. for 2.5 hours to produce a bond magnet. The obtained bond magnet was measured for magnetic characteristics at room temperature to find that residual magnetization was 0.84 T, and coercive force was 350 kA/m.

### Example 2

The quenched thin alloy strip produced in the same manner as in Example 1 described above was pulverized to a particle size of 100 μm or less by using a mortar without performing the heat treatment. The alloy powder was subjected to spark plasma sintering at 700° C. for 15 minutes to produce a disk-shaped sintered magnet having an outer diameter of 10 mm and a thickness of 7 mm. The obtained sintered magnet was measured for magnetic characteristics at room temperature to find that residual magnetization was 1.01 T, and coercive force was 345 kA/m.

### Examples 3 to 7

The quenched thin alloy strips having the compositions shown in Table 1 were produced in the same manner as in Example 1, vacuum-sealed in individual quartz tubes, and heated at the temperatures shown in Table 1 for one hour. To produce the quenched thin alloy strips, the circumferential velocities of the roll shown in Table 1 were applied. The obtained magnet materials (thin alloy strips) were measured for the magnetic characteristics in the same manner as in Example 1. The compositions, average thickness, production conditions and magnetic characteristics of the magnet materials are shown in Table 1. The individual magnet materials each are substantially formed of the TbCu₇ crystal phase in the same manner as in Example 1, and it was confirmed that a ratio of lattice constants (c/a) of the TbCu₇ crystal phase was also same as in Example 1. It was also confirmed that the average crystal grain diameter of the magnet material had the same value as in Example 1.

### Comparative Examples 1 to 3

The quenched thin alloy strips having the compositions shown in Table 1 were produced in the same manner as in Example 1, vacuum-sealed in individual quartz tubes, and heated at the temperatures shown in Table 1 for one hour. The obtained magnet materials (thin alloy strips) were measured for the magnetic characteristics in the same manner as in Example 1. The compositions, average thickness, production conditions and magnetic characteristics of the magnet materials are shown in Table 1.

TABLE 1

| | | Production | | | | |
|---|---|---|---|---|---|---|
| | | Conditions | | | | |
| | | | Average | | Magnetic | |
| | | Circumferential | Thickness | Heat | Characteristics | |
| | | Velocity | of Thin | Treatment | Residual | Coercive |
| | Composition | of Roll | Strip | Temperature | Magnetization | Force |
| | (at. %) | (m/s) | (μm) | (° C.) | (T) | (ka/m) |
| Example 1 | Sm_{8.0}Nb_{3.4}B_{3.8}Co_{14.4}Fe_{bal.} | 30 | 22 | 650 | 1.03 | 360 |
| Example 3 | Sm_{9.0}Nb_{2.3}B_{3.4}Co_{17.5}Fe_{bal.} | 35 | 19 | 600 | 1.02 | 420 |
| Example 4 | Sm_{8.3}Nd_{1.0}Nb_{1.9}Zr_{0.7}B_{2.5}Co_{15.5}Fe_{bal.} | 30 | 24 | 600 | 1.06 | 330 |
| Example 5 | Sm_{8.5}Pr_{0.2}Nb_{2.6}B_{2.2}Co_{16.5}Si_{1.5}Fe_{bal.} | 40 | 15 | 650 | 1.05 | 400 |
| Example 6 | Sm_{8.8}Nb_{2.5}B_{3.8}Co_{18.3}Fe_{bal.} | 25 | 30 | 620 | 1.04 | 350 |
| Example 7 | Sm_{8.6}Ce_{0.4}Nb_{2.3}B_{3.2}Co_{13.0}Cu_{0.1}Fe_{bal.} | 30 | 22 | 650 | 1.01 | 335 |
| Comparative | Sm_{9.0}Nb_{2.3}B_{4.5}Co_{17.5}Fe_{bal.} | 35 | 18 | 600 | 0.92 | 430 |
| Example 1 | | | | | | |
| Comparative | Sm_{10.4}Nb_{0.9}B_{3.4}Co_{17.5}Fe_{bal.} | 35 | 20 | 600 | 0.95 | 220 |
| Example 2 | | | | | | |
| Comparative | Sm_{3.8}Nb_{2.3}B_{3.4}Co_{18.5}Fe_{bal.} | 30 | 24 | 600 | 0.15 | 82 |
| Example 3 | | | | | | |

It is apparent from Table 1 that the magnet materials of the individual examples are excellent in coercive force and residual magnetization. Meanwhile, both the magnet material of Comparative Example 1 having boron in a large amount and the magnet material of Comparative Example 2 having boron in a reduced amount but niobium in an insufficient amount have residual magnetization in an insufficient value. In addition, the magnet material of Comparative Example 3 having a small rare earth element amount (Sm amount) has both coercive force and residual magnetization in an insufficient value.

The magnet material according to the above embodiments can be used effectively as a component material of the permanent magnet. In addition, the permanent magnet can be used effectively for the permanent magnet motor and the electric generator.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnet material, comprising:
a composition represented by a general formula:
Rₓ(Nb₁₋ₚZrₚ)_{y}B_{Z}(T_{1-q}M_{q})_{100-x-y-z}
where, R is at least one element selected from rare earth elements, and 50 at. % or more of R is Sm,
T is Fe alone or a mixture of Fe and Co containing 50 at. % or more of Fe,
M is at least one element selected from Ni, Cu, V, Cr, Mn, Al, Si, Ga, Ta and W,
p is a number (atomic ratio) satisfying 0≦p≦0.5,
q is a number (atomic ratio) satisfying 0≦q≦0.2,
x is a number satisfying 4≦x≦15 at. %,
y is a number satisfying 1≦y≦4 at. %,
z is a number satisfying 0.001≦z<4 at. %; and
a structure including a TbCu₇ crystal phase as a main phase.

2. The magnet material according to claim 1,
wherein a ratio (c/a) of a lattice constant c to a lattice constant a of the TbCu₇ crystal phase is 0.860 or more.

3. The magnet material according to claim 2,
wherein the magnet material is formed of a thin alloy strip having an average thickness in a range from 10 μm to 30 μm.

4. A permanent magnet comprising the magnet material according to claim 1.

5. The permanent magnet according to claim 4,
wherein a mixture of the magnet material and a binder is provided.

6. The permanent magnet according to claim 4,
wherein a pressure sintered body of the magnet material is provided.

7. A permanent magnet motor comprising the permanent magnet according to claim 4.

8. The permanent magnet motor according to claim 7,
wherein the permanent magnet is a variable magnet.

9. An electric generator comprising the permanent magnet according to claim 4.

10. The electric generator according to claim 9,
wherein the permanent magnet is a variable magnet.
